(19) United States
(12) Patent Application Publication
(10) Pub. No.: US 2009/0189942 A1
(43) Pub. Date: Jul. 30, 2009

(54) HUMIDITY CONTROLLED CONTAINER FOR DEVICE INCLUDING A LIQUID

(76) Inventor: Brian G. Price, Pittsford, NY (US)

Correspondence Address: David A. Novais;Patent Legal Staff, Eastman Kodak Company, 343 State Street, Rochester, NY, 14650-2201, US

(21) Appl. No.: 12/020,603

(22) Filed: Jan. 28, 2008

(51) Int. Cl. B41J 29/393

(52) U.S. Cl. 347/19

(57) ABSTRACT

A container assembly includes a container including an inside and an outside, the container being sealed to isolate an environment inside the container from an environment outside the container. An electronic device is disposed inside the container. The electronic device includes an internal cavity, the internal cavity including a liquid. A predetermined mass of desiccant material is disposed inside the container. An air path exists between the desiccant material and the liquid in the internal cavity of the electronic device. The predetermined mass of desiccant material and the liquid maintain a humidity level of the environment inside the container within a desired range.

### FIELD OF THE INVENTION

This invention relates generally to the field of humidity controlled containers, and in particular to a shipping or storage container for an inkjet printhead that includes a liquid therein, the container providing and maintaining a humidity level within a desired range.

### BACKGROUND OF THE INVENTION

An inkjet printing system typically includes one or more printheads and their corresponding ink supplies. Each printhead includes an ink inlet that is connected to its ink supply and an array of drop ejectors, each ejector consisting of an ink chamber, an ejecting actuator and an orifice through which droplets of ink are ejected. The droplets are typically directed toward paper or other print medium in order to produce an image according to image data that is converted into electronic firing pulses for the drop ejectors as the print medium is moved relative to the printhead. The ejecting actuator may be one of various types, including a heater that vaporizes some of the ink in the chamber in order to propel a droplet out of the orifice, or a piezoelectric device which changes the wall geometry of the chamber in order to generate a pressure wave that ejects a droplet. In general, whatever the type of ejecting actuator, it is powered and controlled electronically. In this sense, an inkjet printhead is one example of an electronic device.

Inkjet printheads are an example of a class of electronic devices that are designed to function with liquids. The presence of liquids, especially at elevated temperature presents reliability issues which need to be addressed for proper long-term operation of the electronic device. Conductive metal lines in electronic devices are typically made of metals that may include aluminum or copper. Such metals may be subject to corrosion if exposed to liquids, via chemical or electrochemical interactions, especially if ionic materials are present. This can cause electrical shorts or opens, particularly for microelectronic devices having small conductive lines and small spaces between adjacent conductive lines. The corrosion-sensitive metals are typically passivated with organic or inorganic materials. Still, manufacturing defects, or manufacturing processes such as trimming off the edges of a circuit board near the conductors, can expose the metals to corrosion. Elevated temperatures, such as those that may occur during shipping or storage, may accelerate the chemical interactions and significantly shorten the useful lifetime of the device. In addition, some materials which are effective in protecting against corrosion at lower temperatures and humidities are less effective at higher temperatures and humidity, as their permeability to moisture increases.

It has been known for many years that the reliability of an electronic device can be preserved by keeping it in a dry environment where a low humidity environment is provided by a desiccant. For example, U.S. Pat. No. 3,326,810 describes various forms of providing a silica gel desiccant for electronic devices or other applications and using the desiccant dry out the air in the vicinity of the sensitive device. Moisture from the air is adsorbed into the desiccant. While “the drier the better” is a good rule for most electronic devices, some electronic devices such as inkjet printheads are actually shipped with liquid in them, and too dry an environment can adversely affect the subsequent reliability of operation.

Inkjet ink includes a variety of volatile and nonvolatile components including pigments or dyes, humectants, image durability enhancers, and carriers or solvents. A key consideration in ink formulation is the ability to produce high quality images on the print medium. During periods when ink is not being ejected from an ejector, the volatile components of the ink may evaporate through the nozzle, or there may be other factors why the ink properties (such as viscosity) at the nozzle may change. Such changes can make the drop ejection process nonuniform, so that the image quality may be degraded. Image quality may also be degraded by the presence of manufacturing defects, particularly in the drop ejector region. Such defects may include mechanical defects that cause asymmetry in a nozzle, or contamination defects that partially obstruct a nozzle, or out-of-tolerance geometries, or electrical defects. As not all defects are easily detected during manufacturing, it is common to print test each printhead after manufacturing is completed. The print testing fluid typically contains the same type of components as inkjet ink, and may in fact be an inkjet ink. The print test may be evaluated by inspecting the presence or absence or position of resulting dots on a test medium. Following the print test, it is necessary to flush the print test fluid out of the printhead. It is found however that complete cleanout of all residual test fluid is very difficult. If some residual test fluid remains after flushing, the volatile components may dry out during subsequent shipping of the printhead, resulting for example in plugged nozzles that are very difficult to clean out. The ironic result then is that the very print test that was meant to ensure delivery of only high quality printheads may help to degrade those printheads. A common strategy is to ship the printhead with a shipping fluid in the ink path passages of the printhead. This shipping fluid is put into the printhead following the flushing of the printhead. The shipping fluid may be ink, but more typically the shipping fluid would not include some of the components (such as the colorants) which might be more likely to contribute to nozzle clogging as the volatiles evaporate. Shipping fluid could be as simple as water, although it might also include a humectant such as glycerine, as well as a biocide.

Printheads may be shipped or stored within a container such as a sealed bag which is somewhat resistant to moisture loss. Thus the shipping fluid is prevented from drying out and can keep the nozzles wet enough to prevent persistent clogging. Any remaining clogs can therefore be easily removed during printhead installation and maintenance in the printer. However, during shipping and storage of the printheads prior to sale to the user, the printheads may encounter elevated temperatures such as 60° C. in a warehouse for extended periods of time. Since the printhead container (sealed bag) contains liquid, such an elevated temperature may result in a humidity level of about 95% at the elevated temperature. As indicated above, such elevated levels of temperature and humidity can compromise the reliability of the printhead electronics and metal interconnection lines.

Using desiccants to keep shipping containers within a range of humidity levels, and not just as dry as possible is known. For example, U.S. Pat. No. 5,529,177 discloses the use of panels for trucks or railroad cars, where the panels include a desiccant. Furthermore, for cargo that requires an elevated humidity shipping environment (particularly when shipping through dry regions), water may be added to keep the humidity control panels moist. In addition, US Patent application Publication No. 2006/0144733 discloses hydrating a humidity control substance (i.e. a desiccant such as silica gel) to a desired moisture content prior to enclosing it in the storage container with a moisture-sensitive product. The hydration may be accomplished by exposing the desiccant to a high humidity environment. The hydrated desiccant maintains the humidity in the container within a desired range so that the moisture-sensitive material does not change its moisture content excessively.

What is still needed, however, is an inexpensive shipping or storage container for a liquid-containing device that includes a predetermined amount of desiccant relative to the amount of liquid within the device, in order to establish and maintain the humidity in the container within a desired range.

### SUMMARY OF THE INVENTION

According to one feature of the present invention, a container assembly includes a container including an inside and an outside, the container being sealed to isolate an environment inside the container from an environment outside the container. An electronic device is disposed inside the container. The electronic device includes an internal cavity, the internal cavity including a liquid. A predetermined mass of desiccant material is disposed inside the container. An air path exists between the desiccant material and the liquid in the internal cavity of the electronic device. The predetermined mass of desiccant material and the liquid maintain a humidity level of the environment inside the container within a desired range.

According to another feature of the present invention, a method of maintaining a humidity level of an environment within a container including an electronic device disposed therein includes providing a container including an inside and an outside; providing an electronic device including an internal cavity; adding a liquid to the internal cavity of the electronic device; disposing the electronic device inside the container; disposing a predetermined mass of desiccant material inside the container; providing an air path between the desiccant material and the liquid in the internal cavity of the electronic device, the predetermined mass of desiccant material and the liquid maintaining a humidity level of the environment inside the container within a desired range; and sealing the container to isolate the environment inside the container from an environment outside the container.

### BRIEF DESCRIPTION OF THE DRAWINGS

FIG. 1 is a perspective view of an inkjet printhead together with associated ink supplies;

FIG. 2 is a perspective view of a printhead chassis rotated so that the printhead die can be seen;

FIG. 3 is a perspective view of a printhead chassis without the associated ink supplies;

FIG. 4 is a schematic view of printhead enclosed in a container including a desiccant;

FIG. 5 is a schematic view of a printhead and desiccant enclosed in a partially evacuated bag;

FIG. 6 is a plot and linear regression of moisture absorption properties of silica gel;

FIG. 7 is a plot of the mass of desiccant needed to provide a range of different relative humidities for a first amount and composition of shipping fluid; and

FIG. 8 is a plot of the mass of desiccant needed to provide a range of different relative humidities for a second amount and composition of shipping fluid.

### DETAILED DESCRIPTION OF THE INVENTION

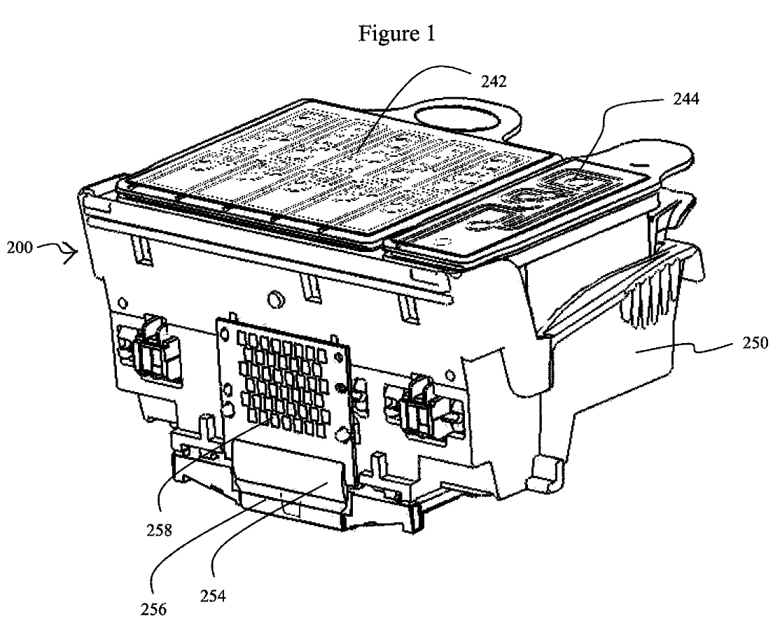

FIG. 1 shows a perspective view of inkjet printhead 200 together with associated multichamber ink supply 242 and single chamber ink supply 244. Printhead 200 includes a printhead chassis 250 into which ink supplies 242 and 244 may be inserted prior to printing. In this example, printhead 200 also includes flex circuit 254, electrical connector board 258, and interconnection region 256 between flex circuit 254 and electrical connector board 258. The mound of material indicated by 256 is an encapsulant over the interconnection region 256. Interconnection region 256 is one region of printhead 200 which may be susceptible to damage by sustained exposure to high humidity and elevated temperature. In some instances this may be further aggravated when electrical connector board 258 is connected to electrical power after the printhead is installed in the printer.

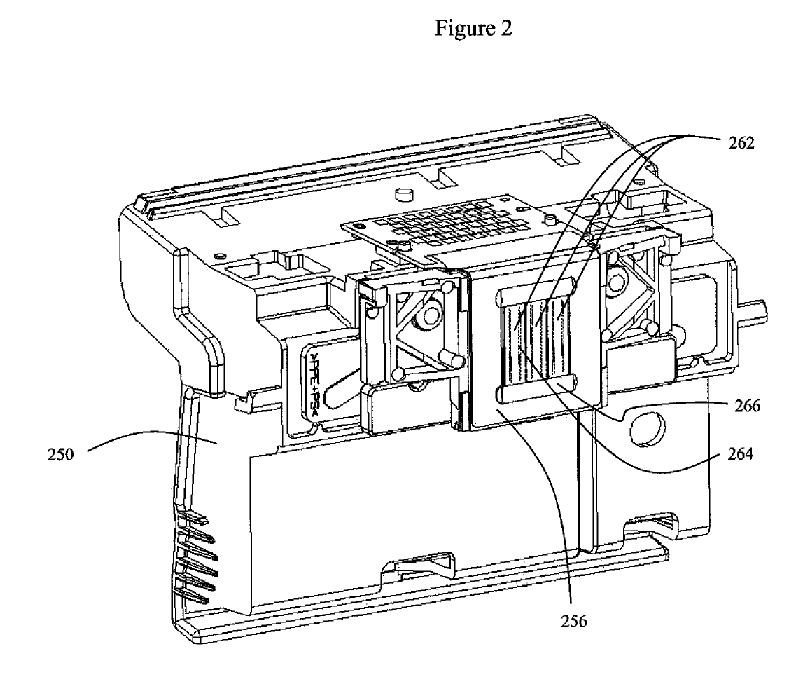

FIG. 2 shows a perspective view of the printhead chassis 250, but rotated relative to FIG. 1, so that the printhead die 262 can be seen on the bottom of printhead chassis 250. In the example of FIG. 2 there are three printhead die 262, each containing two nozzle arrays 264. The flex circuit 254 is bent around the corner of printhead chassis 250 and extends from a region adjacent to electrical connector board 258 to a region that surrounds the printhead die 262. Flex circuit 254 provides electrical connection between printhead die 262 and the electrical connector board 258. Wire bonds, TAB bonds, or other type of interconnection is provided to connect the printhead die 262 to the flex circuit 254, and the wire bonds are covered by an encapsulant 266. Individual nozzles are not shown in the nozzle arrays 264 in FIG. 2, but the nozzle diameters are typically on the order of 10 to 20 microns, in order to provide drop sizes in the several picoliter range that is required for high quality printing. With such small nozzles, it can be readily seen that nozzle clogging could be an issue. This is especially true with modern pigmented inkjet inks which provide long lasting high quality color prints.

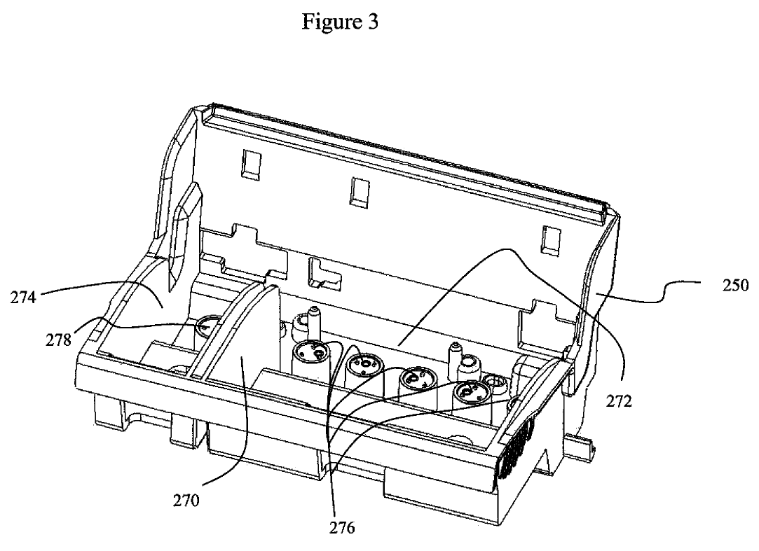

FIG. 3 shows a perspective view of printhead chassis 250 without the associated ink supplies 242 or 244. FIG. 3 is rotated relative to FIG. 1, such that the printhead die 262 are not visible (being below the chassis 250 in this orientation) and the electrical connector board 258 is not visible (being behind the chassis 250 in this orientation). In FIG. 3, a partitioning wall 270 within the printhead chassis 250 separates the region 272 where multichamber ink supply 262 may be installed from region 274 where single chamber ink supply 264 may be installed. In region 262, five ink ports 276 may be seen (one of the ports 276 being partly hidden). Ink ports 276 correspond to openings in the multichamber ink supply 242. The number of ink ports 276 corresponding to openings in the multichamber ink supply 242 is not limited to five, but typically is a number between 2 and 8. In addition is an ink port 278 corresponding to the single chamber ink supply 244. During printing, ink is provided from the ink supplies 242 and 244 to the nozzles of the printhead die 262 through internal ink passageways that are not visible in FIG. 3. The ink passages extend between ports 276 and nozzle arrays 264. In this embodiment, the ink passages and any internal ink reservoirs within printhead chassis 250 and die 262 are included in an internal cavity in which liquid ink or shipping fluid may reside. For this embodiment where the printhead chassis 250 is shipped and stored separately from ink supplies 242 and 244, the ink in those ink supplies is not considered to be within the cavity. However, for some other embodiments in which the ink supply is integrated together with the printhead, it can be appropriate to consider the ink supply as part of the internal cavity.

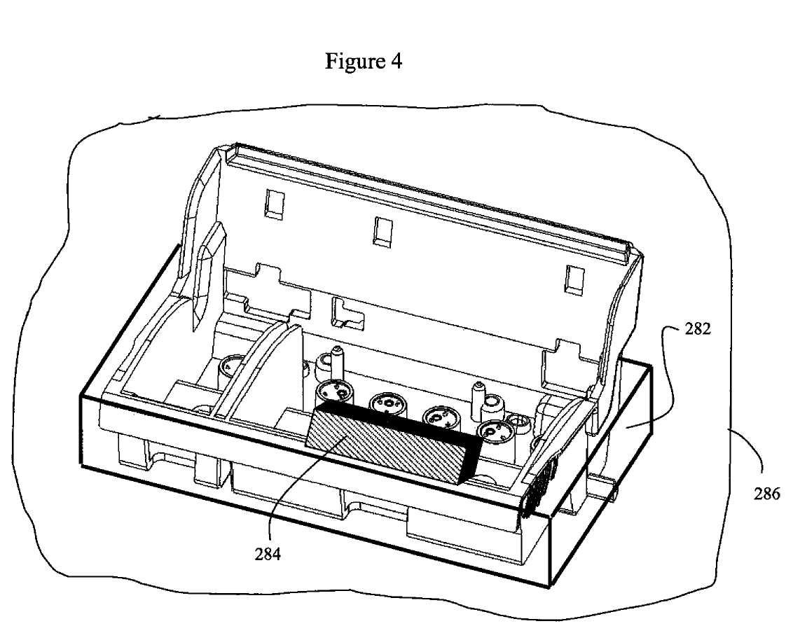

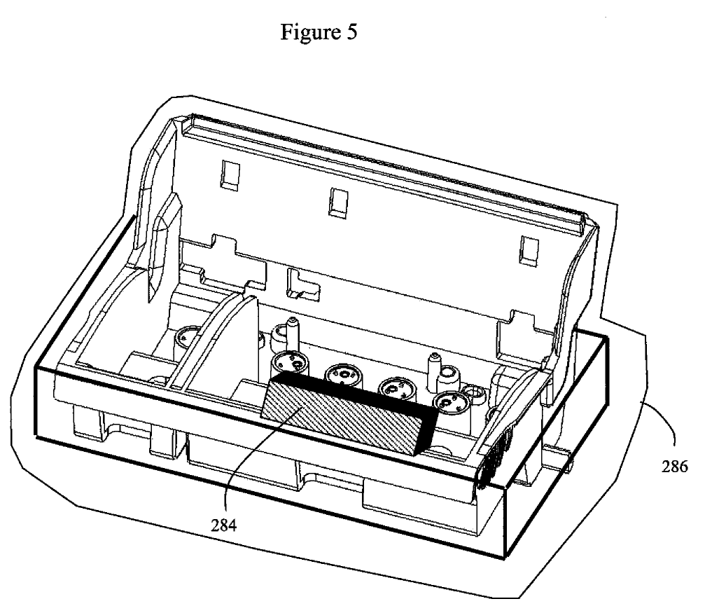

Referring to FIGS. 4 and 5, during printhead manufacturing and subsequent to print testing printhead 200 for quality control, the print testing fluid is flushed out of the printhead and a shipping fluid is added through the ports 276 and 278. In one embodiment, the shipping fluid may be composed of 80% water and 20% glycerine. Although the water may have a relatively high vapor pressure at the elevated temperatures encountered during shipping and storage, the glycerine (as a humectant) would have a very low vapor pressure over this range. The amount of shipping fluid that is added depends somewhat upon printhead geometries. In a geometry such as shown in FIGS. 1-3, where there are on the order of five or six ports 276 and 278 in total, and the ink passages must extend 3 centimeters or more from the ink ports 276 and 278 to the nozzle arrays 264, the amount of shipping fluid may be approximately 0.5 gram. For a smaller printhead with only one port, the amount of shipping fluid may be on the order of 0.1 gram. For a larger printhead, the shipping fluid may be as much as 2 grams or more. The printhead is then placed into a low permeability enclosure such as a bag together with a predetermined amount of desiccant material, such as silica gel, and then the bag is sealed. Optionally, additional plastic parts are placed around the printhead prior to sealing the bag for mechanical protection of the printhead. For example, the region of printhead chassis 250 that includes printhead die 262 may be placed in a plastic tray 282, and the region around the ink ports 276 and 278 may have a plastic retainer (not shown) in contact with a gasket surrounding the ink port region. However, there is an air path from the shipping fluid in the internal passages of the printhead via the nozzle arrays 264 and/or via the ink ports 276 and 278. Optionally, after the printhead chassis 250, the plastic packaging, and the desiccant are placed into the low permeability enclosure, the enclosure or bag is at least partially evacuated. This helps to hold loose parts in position and the collapse of the bag makes it more compact. FIG. 4 schematically represents printhead chassis 250, tray 282 for protecting printhead die 262, packet of desiccant 284, and container (or bag) 286. FIG. 5 is similar to FIG. 4, but the bag 286 has been partially evacuated, so that it is smaller and its shape corresponds more closely to the objects inside the bag. The packet 284 that encloses the desiccant is typically made of a material that allows water vapor to pass through it. In this sense, the packet is water vapor permeable. In the embodiments shown in FIGS. 4 and 5, there is no need to hydrate the desiccant prior to placing the desiccant in the enclosure because of the presence of the liquid in the device.

Offline testing of degradation of printhead reliability through observation of moisture condensation and corrosion or hydrolysis of electronic components at high humidity at elevated temperature, as well as extensive and persistent nozzle clogging at low humidity and elevated temperature can determine a desirable humidity range to maintain within the shipping or storage container. The elevated temperature in the test may be chosen to represent typical or extreme conditions encountered during warehouse storage, for example.

Once the desired target humidity level is known, as well as the quantity and composition of shipping fluid, the appropriate amount of desiccant may be calculated. Without being overly constrained by theory, the following analysis provides an understanding of how to calculate a predetermined amount of desiccant that is appropriate. In this embodiment, silica gel is the particular desiccant described, but it is straightforward to adjust for other desiccant materials, as described below.

Inside a low permeability enclosure, such as the printhead shipping bag, the moisture in the atmosphere within the enclosure will reach an equilibrium with that solution. The humidity c, and the equilibrium between solution and vapor can be described to an adequate extent utilizing Raoult's Law,

$$c ≡ \frac{{P}_{{H}_{2} O}}{{P}_{{H}_{2} O , 0}} = \frac{( \frac{{m}_{w , s}}{{M}_{w}} )}{( \frac{{m}_{w , s}}{{M}_{w}} + \frac{{m}_{h , s}}{{M}_{h}} )} , \qquad ( 1 )$$

i.e. the partial pressure of water in the contained atmosphere P_{H}_{₂}_{O}, is equal to the saturation vapor pressure of water, P_{H}_{₂}_{O,0}, multiplied by the mole fraction of water in the solution, where m_{w,s} and m_{h,s} are the mass of water and humectant in solution, and M_{w} and Mₕ are the molecular masses of water and humectant. The relative humidity inside the container is then c.

Silica gel has a porous structure that adsorbs moisture reversibly and exhibits little dimensional change with degree of moisture adsorption. By adsorbing moisture reversibly it is meant that water that is adsorbed is not held permanently, but may be driven off—for example by exposing the silica gel to elevated temperature at low humidity. If the desiccant material is considered to have a finite number of sites to which the water molecules can be adsorbed, the adsorption process is naturally limited. Perhaps the simplest model of adsorption of molecules onto binding sites was provided by Langmuir, as is described in standard textbooks on physical chemistry. In Langmuir's model of adsorption, it is assumed that a) all adsorption sites are equal, b) adsorbed molecules do not interact, c) all adsorption occurs through the same mechanism, and d) at the maximum adsorption only a monolayer is formed (i.e. only one water molecule per adsorption site). The binding rate of water molecules to the desiccant is determined by the number of sites present and the concentration of moisture vapor,

$$\frac{\partial w}{\partial t} = {k}_{b} {cd}_{u} - {k}_{u} w \qquad ( 2 )$$

where w is the amount of adsorbed water relative to the amount of desiccant, c is the water vapor concentration (RH), d is a dimensionless number indicative of the binding site concentration, and k are the rate constants, where the subscripts b and u indicate binding and unbinding.

At steady state, the binding rate is zero and the behavior of the desiccant can be described by,

w=Kdᵤc

where K=k_{b}/kᵤ. (3)

Since there is a one-to-one correspondence between sites and water molecules, and the total number of sites is constant,

$$w = {d}_{b} \\ d = {d}_{b} + {d}_{u} \\ w = \frac{Kdc}{( 1 + Kc )} \qquad ( 3 )$$

Experimentally, K and d may be determined by measuring the equilibrium uptake amounts of moisture as a function of relative humidity c (RH) and applying linear regression to the following equation (where equation 5 is simply a rearrangement of the terms in equation 4),

$$\frac{1}{c} = Kd \frac{1}{w} - K \qquad ( 4 )$$

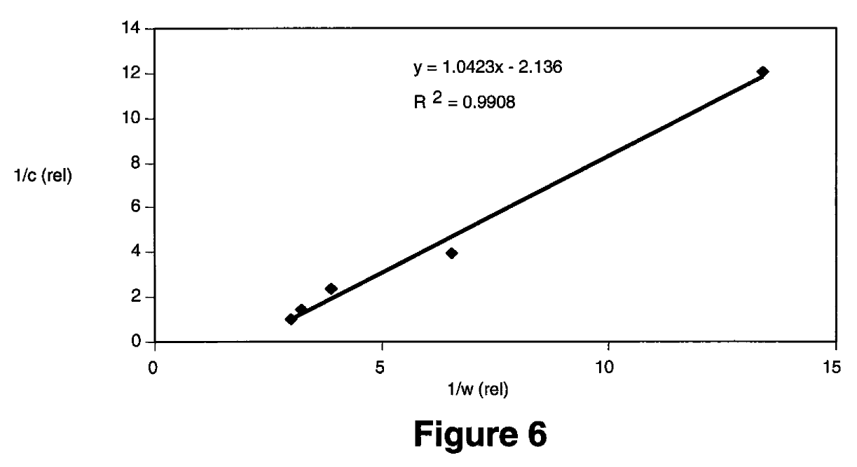

FIG. 6 shows a plot of 1/c vs 1/w for the case of silica gel samples that were allowed to equilibrate under various humidity conditions at 60° C. The equation of line fitting the data is shown in FIG. 6, and from this we get K=2.136, and Kd=1.042, so that d=0.488. Note that the degree of correlation is given by R²=0.99, so the fit to the data is good.

With K and d known, the amount of adsorbent material needed to reach a desired equilibrium humidity level with a given solution may be calculated from equation (4). As a working example, we take a shipping fluid having a water mass fraction of x_{w}, the total amount of water in the system is then

m_{w,t}=x_{w}S, (5)

where S is the mass of shipping fluid remaining in the printhead at the time of packaging. Note: the amount of moisture in the atmosphere is on the order of 0.00001 grams per mL of air, so that with about 100 mL of air in the printhead bag, the moisture in the air is only about 0.001 gram, which is negligible compared to at least 0.1 g liquid water in the printhead.

At equilibrium, the water is distributed between the mass of water m_{w,s} in the humectant solution and the mass of water m_{w,d} that is in the desiccant,

m_{w,t}=m_{w,s}+m_{w,d}. (6)

From equations (1), (6) and (7) it may be shown that at the desired humidity c₀, the mass of water that must be adsorbed onto the desiccant is given by

$${m}_{w , d} = {m}_{w , t} ( 1 - \frac{{c}_{0}}{( 1 - {c}_{0} )} \frac{( 1 - {x}_{w} )}{{x}_{w}} \frac{{M}_{w}}{{M}_{h}} ) . \qquad ( 7 )$$

From equation (3), the mass of desiccant m_{d} needed to achieve the desired humidity c₀ is then given by

$$\begin{matrix}{m}_{d} = {m}_{w , d} \frac{( 1 + {Kc}_{0} )}{{Kdc}_{0}} \\ = {m}_{w , t} ( 1 - \frac{{c}_{0}}{( 1 - {c}_{0} )} \frac{( 1 - {x}_{w} )}{{x}_{w}} \frac{{M}_{w}}{{M}_{k}} ) \\ \frac{( 1 + {Kc}_{0} )}{{Kdc}_{0}}\end{matrix} \qquad ( 8 )$$

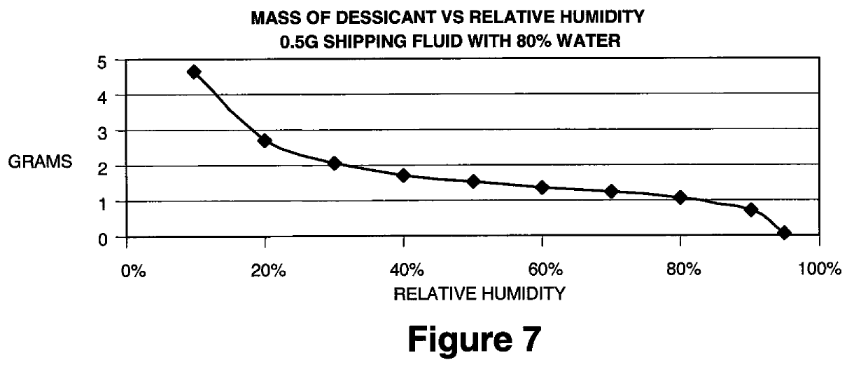

FIG. 7 shows the mass of desiccant m_{d} needed to achieve various a range of different relative humidities. In this example it is assumed that the mass of shipping fluid is 0.5 gram, and that its composition is 80% water and 20% glycerine as a humectant. The molecular weight M_{w} of water is 18.015 and the molecular weight Mₕ of glycerine is 92.064. K and d in this example are those derived above for silica gel at 60° C., K=2.136 and d=0.488. Under these conditions, a mass of 2.0 grams of silica gel will provide a relative humidity of about 30% at equilibrium at 60° C., while a mass of about 1.0 gram of silica gel will provide a relative humidity of about 80%. While the curve is relatively steeper below 20% and above 90% relative humidity, in the range of 30% to 80% relative humidity, a reasonable approximation is that for each additional 0.2 gram of silica gel, the equilibrium relative humidity drops by about 10%.

Note from equation (9) that the mass of desiccant required for a given humidity level is directly proportional to the mass of water in the shipping fluid. Suppose that the composition of the shipping fluid is unchanged (80% water and 20% glycerine), but the printhead has larger ink passageways or more ink ports 276 so that 1 gram of shipping fluid is required rather than 0.5 gram. In such a case, the mass of silica gel required would need to be doubled to 4 grams for 30% relative humidity and 2 grams for 80% relative humidity. Similarly, for a smaller printhead with only a single ink port 276, the mass of shipping fluid would be decreased to perhaps 0.1 gram and the mass of silica gel required for 80% relative humidity would be about 0.2 gram.

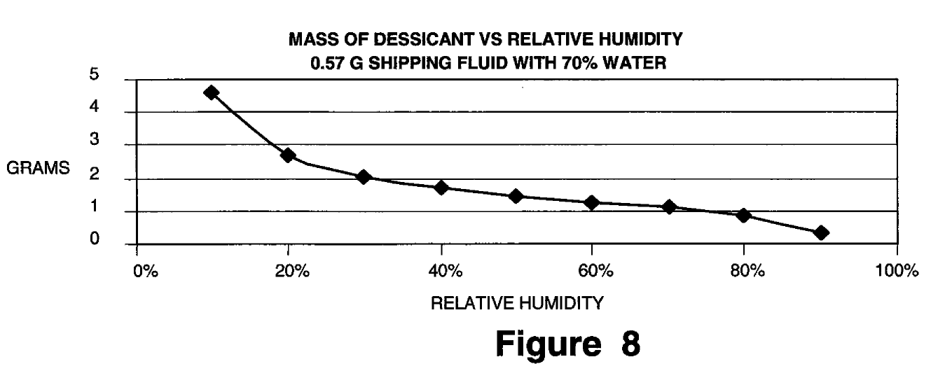

Comparison of FIG. 7 and FIG. 8 shows the effect of a change in the concentration of shipping fluid. In the example of FIG. 8, the mass of water is 0.4 gram as in the example of FIG. 7, but the composition of the shipping fluid is 70% water and 30% glycerine. The total mass of the shipping fluid in this example is about 0.57 gram. As can be seen, the amount of silica gel required to provide a 10% relative humidity is essentially unchanged at 4.6 gram, and the amount of silica gel required for 30% relative humidity is still about 2.0 gram. However, between 30% and 80% relative humidity in the example of FIG. 8, a bit more silica gel (0.23 gram) is required to be added in order to achieve a 10% drop in relative humidity.

Testing of printheads under the shipping and storage conditions of the example of FIG. 7 was carried out in order to validate the analysis. Printheads were stored in shipping bags for two weeks at 60° C. with either 0 gram, 1 gram, 2 grams or 5 grams of silica gel in the shipping bag and 0.5 gram of shipping fluid in the printhead. The printheads were then examined relative to a) corrosion of sensitive areas, b) condensation of moisture on the printhead, c) hardness and adhesion of organic materials on the printhead, and d) number of nozzles that failed to print when print tested after removal from the bag. Conditions a), b) and c) are expected to be worse at high humidity storage, while condition d) is expected to be worse at low humidity storage. It was found that for printheads stored with 1 gram of silica gel, acceptable levels of corrosion, condensation, adhesion, hardness and number of nonprinting nozzles were achieved, while for no silica gel the corrosion, condensation, adhesion and hardness were not acceptable. The 1 gram of silica gel is expected to provide a relative humidity of about 80% under these conditions, while with no silica gel the relative humidity would be about 95%. For printheads stored with 2 grams or more of silica gel (30% relative humidity or lower), corrosion, condensation, adhesion and hardness remained acceptable, but there were too many nonprinting nozzles. For 2 grams of silica gel, the nonprinting nozzles were restored to normal operation with a single cleaning operation, but for 5 grams of silica gel, multiple cleaning cycles were required to restore the nonprinting nozzles to normal operation. Multiple cleaning cycles is wasteful of ink. Thus, under these shipping and storage conditions, an acceptable relative humidity range is about 80% to 40%, corresponding to an amount of silica gel of about 1.0 gram to about 1.8 grams respectively.

The invention has been described in detail with particular reference to certain preferred embodiments thereof, but it will be understood that variations and modifications can be effected within the scope of the invention.

### PARTS LIST

200 inkjet printhead
242 multichamber ink supply
244 single chamber ink supply
250 printhead chassis
254 flex circuit
256 interconnection region
258 electrical connector board
262 printhead die
264 nozzle array
266 encapsulant
270 partitioning wall
272 region for multichamber supply
274 region for single chamber supply
276 ink ports
278 ink port
282 tray
284 packet of desiccant
286 container or bag

1. A container assembly comprising:
a container including an inside and an outside, the container being sealed to isolate an environment inside the container from an environment outside the container;
an electronic device disposed inside the container, the electronic device including an internal cavity, the internal cavity including a liquid;
a predetermined mass of desiccant material disposed inside the container; and
an air path between the desiccant material and the liquid in the internal cavity of the electronic device, wherein the predetermined mass of desiccant material and the liquid maintain a humidity level of the environment inside the container within a desired range.

2. The container assembly of claim 1, wherein the electronic device comprises an inkjet printhead.

3. The container assembly of claim 2, the inkjet printhead comprising a nozzle, wherein the air path includes the nozzle of the inkjet printhead.

4. The container assembly of claim 2, the inkjet printhead comprising an ink port, wherein the air path includes the ink port of the inkjet printhead.

5. The container assembly of claim 2, wherein the internal cavity of the inkjet printhead includes between 0.1 gram and 1 gram of the liquid, and the predetermined mass of desiccant material is between about 0.2 gram and 4 grams.

6. The container assembly of claim 1, wherein the liquid includes a mass of water and a mass of humectant.

7. The container assembly of claim 6, wherein the predetermined mass of desiccant material is dependent upon the mass of water.

8. The container assembly of claim 6, wherein the predetermined mass of desiccant material is dependent upon the ratio of the mass of water to the mass of humectant.

9. The container assembly of claim 1, wherein the container comprises a bag.

10. The container assembly of claim 9, wherein the bag is partially evacuated of air.

11. The container assembly of claim 1, wherein the desiccant material is disposed within a water vapor permeable packet.

12. The container assembly of claim 1, wherein the desired range of the humidity level of the environment inside the container is between about 40% and 80% relative humidity.

13. The container assembly of claim 1, wherein the desiccant material comprises silica gel.

14. A method of maintaining a humidity level of an environment within a container including an electronic device disposed therein comprising:
providing a container including an inside and an outside;
providing an electronic device including an internal cavity;
adding a liquid to the internal cavity of the electronic device;
disposing the electronic device inside the container;
disposing a predetermined mass of desiccant material inside the container;
providing an air path between the desiccant material and the liquid in the internal cavity of the electronic device, the predetermined mass of desiccant material and the liquid maintaining a humidity level of the environment inside the container within a desired range; and
sealing the container to isolate the environment inside the container from an environment outside the container.
